(19) United States
(12) Patent Application Publication
(10) Pub. No.: US 2026/0094961 A1
(43) Pub. Date: Apr. 2, 2026

(54) ANTENNA ARRANGEMENT

(71) Applicant: WNC Corporation, Hsinchu (TW)

(72) Inventors: De Shao YAO, Hsinchu (TW); Chung-Che LIEN, Hsinchu (TW); Chia-Hao CHANG, Hsinchu (TW); Chih Feng TAI, Hsinchu (TW)

(21) Appl. No.: 19/339,393

(22) Filed: Sep. 25, 2025

(30) Foreign Application Priority Data
Sep. 27, 2024 (TW) 113137051

(51) Int. Cl. H01Q 1/22; H01Q 7/00; H01Q 9/04

(52) U.S. Cl. CPC H01Q 1/2266; H01Q 7/00; H01Q 9/0421

(57) ABSTRACT

An antenna arrangement includes an image sensing module and an antenna module. An orthogonal projection of the antenna module partially overlaps the image sensing module. The antenna module includes a first radiating part and a feeding part. The feeding part is disposed on the first radiating part, with a first distance between the feeding part and the image sensing module.

### RELATED APPLICATION

This application claims the benefit of priority to Taiwan Patent Application No. 113137051, filed on Sep. 27, 2024. The entire content of the above identified application is incorporated herein by reference.

### BACKGROUND

### Technical Field

The present disclosure relates to an antenna arrangement, and more particularly, to an antenna arrangement for a notebook computer.

### Description of Related Art

With the increasing functions and performance requirements of electronic devices such as notebook computers, installing an image sensing module at the top of the screen of the A-cover and B-cover of the notebook computer (i.e., the top side of the A-cover and B-cover) can satisfy the demands of artificial intelligence (AI) applications.

However, due to the limited space at the top side of the notebook computer, when an image sensing module has already been placed, it is difficult to allocate additional space for an antenna module.

From this, configuring the antenna module and the image sensing module in a limited space of electronic devices has become a goal worth developing for related industries.

### SUMMARY

It is an aspect of the present disclosure to provide an antenna arrangement that includes an image sensing module and an antenna module. An orthogonal projection of the antenna module partially overlaps the image sensing module. The antenna module includes a first radiating part and a feeding part. The feeding part is disposed on the first radiating part. There is a first distance between the feeding part and the image sensing module.

It is another aspect of the present disclosure to provide an antenna arrangement that includes an image sensing module, an antenna module, and an isolation element. An orthogonal projection of the antenna module partially overlaps the image sensing module, and the antenna module includes two first radiating parts and two feeding parts. The two feeding parts are respectively disposed on the two first radiating parts. The isolation element is electrically connected to the image sensing module and disposed between the two first radiating parts. Each of the two feeding parts is respectively separated from the image sensing module by a first distance.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an antenna arrangement according to a first embodiment of the present disclosure.

FIG. 2 is a side view of the antenna arrangement of the first embodiment shown in FIG. 1.

FIG. 3 is a schematic diagram of an antenna arrangement according to a second embodiment of the present disclosure.

FIG. 4 is a schematic diagram of an antenna arrangement according to a third embodiment of the present disclosure.

FIG. 5 is a schematic diagram of an antenna arrangement according to a fourth embodiment of the present disclosure.

FIG. 6 is a comparative schematic diagram of an isolation degree of the antenna arrangement of the fourth embodiment shown in FIG. 5.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In the present disclosure, when an element (i.e., a unit or a module) is described to “connect” to another element, it means to that the element is directly connected to the other element, or that certain element is indirectly connected to the other element, which implies that there is another element between the element and the other element. When an element is described to “directly connect” to another element, it means to no other element is between the element and the other element.

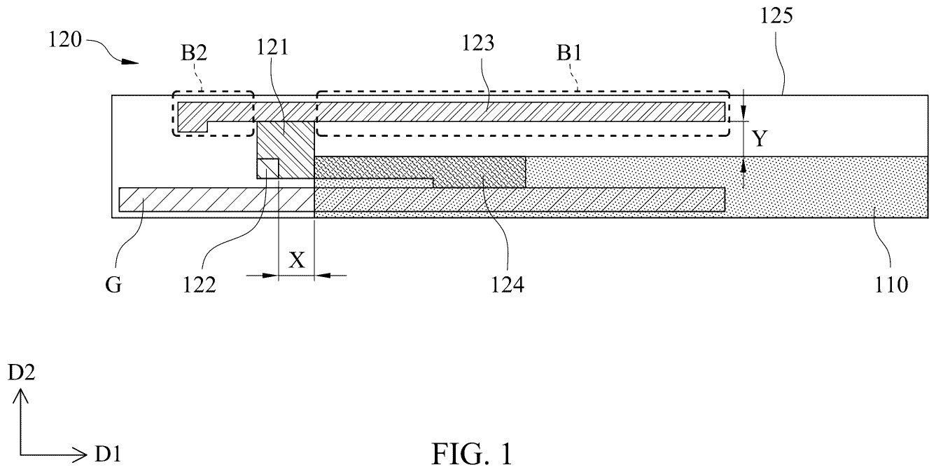

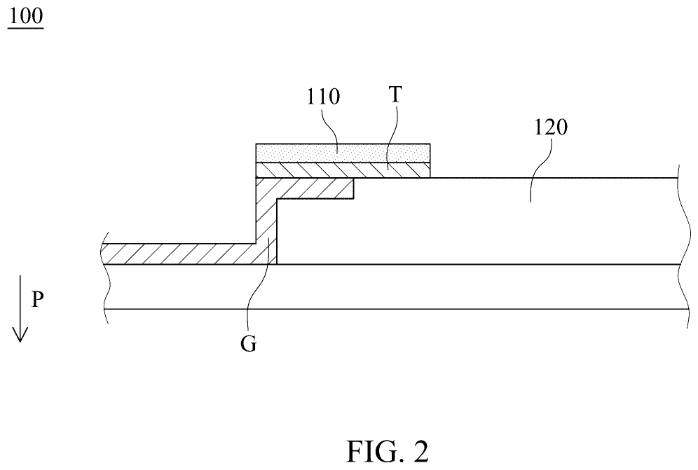

FIG. 1 is a schematic diagram of an antenna arrangement 100 of a first embodiment of the present disclosure, and FIG. 2 is a side view of the antenna arrangement 100 of the first embodiment shown in FIG. 1. Referring to FIGS. 1 and 2, the antenna arrangement 100 includes an image sensing module 110 and an antenna module 120. In the first embodiment, the antenna arrangement 100 is located at the top of the screen of the A-cover and B-cover of a notebook computer (i.e., the top side of the A-cove and B-cove); the image sensing module 110 can be a camera or a low-resolution image sensor of the notebook computer, but the present disclosure is not limited thereto.

An orthogonal projection of the antenna module 120 partially overlaps the image sensing module 110. In the first embodiment, as shown in FIG. 2, the image sensing module 110 is stacked on top of the antenna module 120 along a vertical direction P through a friction tape T (only shown in FIG. 2), making the orthogonal projection of the antenna module 120 partially overlap the image sensing module 110, but the present disclosure is not limited thereto. In other embodiments, the image sensing module can be stacked above the antenna module without contact or by other connection methods.

Thus, through the arrangement of the antenna module 120 and the image sensing module 110, the antenna module 120 and the image sensing module 110 can be disposed at the top side of the A-cove and B-cove of the notebook computer within the limited installation space.

The antenna module 120 includes a first radiating part 121, a feeding part 122, a second radiating part 123, a grounding part 124, and a body 125. The first radiating part 121, the second radiating part 123, and the grounding part 124 are disposed on the body 125, and the feeding part 122 is disposed on the first radiating part 121. The first radiating part 121 is connected to the second radiating part 123 and the grounding part 124, and the body 125 is disposed at the top side of the A-cove and B-cove of the notebook computer. In the first embodiment, the antenna module 120 is a single-antenna (system) or a single antenna and a planar inverted-F antenna (PIFA), but the present disclosure is not limited thereto.

The feeding part 122 is electrically connected to a coaxial transmission line (not shown) and connected to a signal source for feeding the signal. The second radiating part 123 has a radiating area B1 for providing low-frequency radiation and a radiating area B2 for providing high-frequency radiation; for WiFi 7 applications, the low-frequency radiation range is between 2.4 GHz and 2.5 GHz, and the high-frequency radiation range is between 5 GHz and 7 GHz.

The orthogonal projection of the grounding part 124 partially overlaps the image sensing module 110. In other possible embodiments, the image sensing module may overlap with any part of the antenna module. For example, the image sensing module can overlap the second radiating part, but the image sensing module must be kept away from the feeding part to avoid affecting the antenna characteristics, but the present disclosure is not limited thereto.

The grounding part 124 can be connected to a system ground of the notebook computer (not shown) through an antenna ground G, which can be a ground copper foil. The body 125 can be a substrate or carrier board, such as a printed circuit board (PCB) or a flexible printed circuit (FPC), but the present disclosure is not limited thereto.

As shown in FIG. 1, there is a first distance X between the feeding part 122 and the image sensing module 110, and the first distance X is defined as the linear shortest distance between the feeding part 122 and the image sensing module 110. There is a second distance Y between the second radiating part 123 and the image sensing module 110. In the first embodiment, the feeding part 122 has the first distance X from the image sensing module 110 along a first direction D1, and the second radiating part 123 has the second distance Y from the image sensing module 110 along a second direction D2, with the second direction D2 perpendicular to the first direction D1 and the vertical direction P perpendicular to both the first direction D1 and the second direction D2. In the first embodiment, the first distance X is greater than or equal to 0.3 millimeters, and the second distance Y is greater than or equal to 0.3 millimeters, but the present disclosure is not limited thereto.

It should be particularly noted that, the distance between the image sensing module 110 and the feeding part 122 (first distance X) and the distance between the image sensing module 110 and the second radiating part 123 (second distance Y) significantly affect the antenna characteristics of the antenna module 120. As the first distance X and the second distance Y decrease, the antenna characteristics of the antenna module 120 gradually deteriorate. Therefore, in the best case, the first distance X and the second distance Y can be set to ensure that the antenna module 120 maintains optimal antenna characteristics in limited installation space.

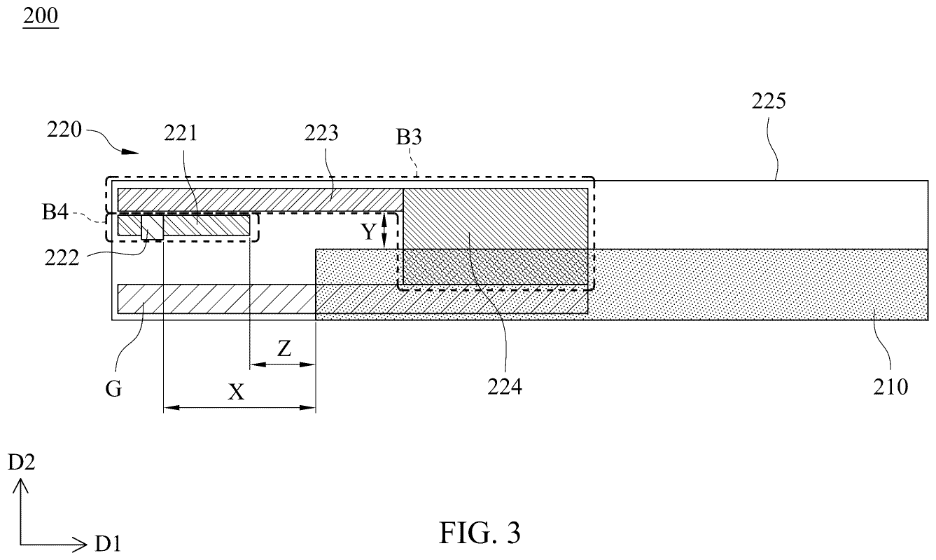

FIG. 3 is a schematic diagram of an antenna arrangement 200 of a second embodiment of the present disclosure. Referring to FIG. 3, the antenna arrangement 200 includes an image sensing module 210 and an antenna module 220. In the second embodiment, the image sensing module 210 is the same as the image sensing module 110 of the first embodiment shown in FIG. 1, and will not be described herein. The difference between the second embodiment and the first embodiment lies in the type of the antenna module 220.

An orthogonal projection of the antenna module 220 partially overlaps the image sensing module 210. The antenna module 220 includes a first radiating part 221, a feeding part 222, a second radiating part 223, a grounding part 224, and a body 225. The first radiating part 221, the second radiating part 223, and the grounding part 224 are disposed on the body 225, and the second radiating part 223 connects the grounding part 224. The second radiating part 223 and the grounding part 224 have a radiating area B3 for providing low-frequency radiation, and the first radiating part 221 has a radiating area B4 for providing high-frequency radiation; for WiFi 7 applications, the low-frequency radiation range is between 2.4 GHz and 2.5 GHZ, and the high-frequency radiation range is between 5 GHz and 7 GHZ. In the second embodiment, the feeding part 222, the grounding part 224, and the body 225 are the same as the feeding part 122, the grounding part 124, and the body 125 of the first embodiment shown in FIG. 1, and will not be described herein; the antenna module 220 is a coupled antenna, but the present disclosure is not limited thereto.

As shown in FIG. 3, in the second embodiment, the feeding part 222 has a first distance X from the image sensing module 210 along the first direction D1, and the second radiating part 223 has a second distance Y from the image sensing module 210 along the second direction D2. The first radiating part 221 has a third distance Z from the image sensing module 210 along the first direction D1. In the second embodiment, the first distance X is greater than the third distance Z; the first distance X is greater than or equal to 0.3 millimeters; the second distance Y is greater than or equal to 0.3 millimeters; and the third distance Z is greater than or equal to 0.3 millimeters, but the present disclosure is not limited thereto.

Thus, through the arrangement of the antenna module 220 and the image sensing module 210, the antenna module 220 and the image sensing module 210 can be disposed within limited installation space. Furthermore, by setting the first distance X, the second distance Y, and the third distance Z, the antenna module 220 can maintain optimal antenna characteristics.

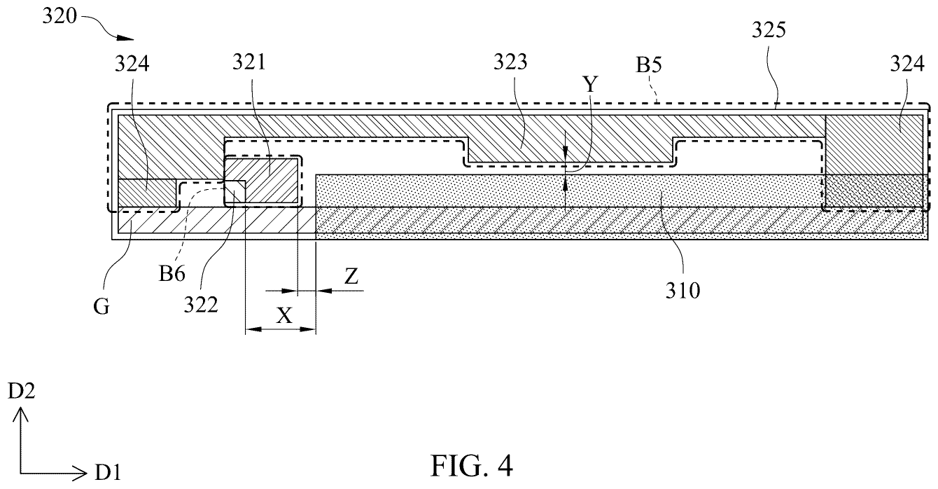

FIG. 4 is a schematic diagram of an antenna arrangement 300 of a third embodiment of the present disclosure. Referring to FIG. 4, the antenna arrangement 300 includes an image sensing module 310 and an antenna module 320. In the third embodiment, the image sensing module 310 is the same as the image sensing module 110 of the first embodiment shown in FIG. 1 and will not be described herein. The difference between the third embodiment and the first embodiment lies in the type of the antenna module 320.

An orthogonal projection of the antenna module 320 partially overlaps the image sensing module 310. The antenna module 320 includes a first radiating part 321, a feeding part 322, a second radiating part 323, at least one grounding part 324, and a body 325. The first radiating part 321, the second radiating part 323, and the grounding part 324 are disposed on the body 325, and the first radiating part 321 connects the second radiating part 323. The number of the at least one grounding part 324 is two, and the two ends of the second radiating part 323 are respectively connected to one grounding part 324. The second radiating part 323, the grounding part 324, and the antenna ground G have a radiating area B5 (the antenna ground G is not separately circled), which is used to provide low-frequency radiation, and the first radiating part 321 has a radiating area B6, which is used to provide high-frequency radiation; for WiFi 7 applications, the low-frequency radiation range is between 2.4 GHZ and 2.5 GHZ, and the high-frequency radiation range is between 5 GHZ and 7 GHZ. In the third embodiment, the feeding part 322 and the body 325 are the same as the feeding part 122 and the body 125 of the first embodiment shown in FIG. 1 and will not be described herein; the antenna module 320 is a loop antenna, but the present disclosure is not limited thereto.

As shown in FIG. 4, in the third embodiment, there is a first distance X between the feeding part 322 and the image sensing module 310 along the first direction D1, and there is a second distance Y between the second radiating part 323 and the image sensing module 310 along the second direction D2. There is a third distance Z between the first radiating part 321 and the image sensing module 310 along the first direction D1. In the third embodiment, the first distance X is greater than the third distance Z; the first distance X is greater than or equal to 0.3 millimeters; the second distance Y is greater than or equal to 0.3 millimeters; and the third distance Z is greater than or equal to 0.3 millimeters, but the present disclosure is not limited thereto.

Thus, through the arrangement of the antenna module 320 and the image sensing module 310, the antenna module 320 and the image sensing module 310 can be disposed within limited installation space. Furthermore, by setting the first distance X, the second distance Y, and the third distance Z, the antenna module 320 can maintain optimal antenna characteristics.

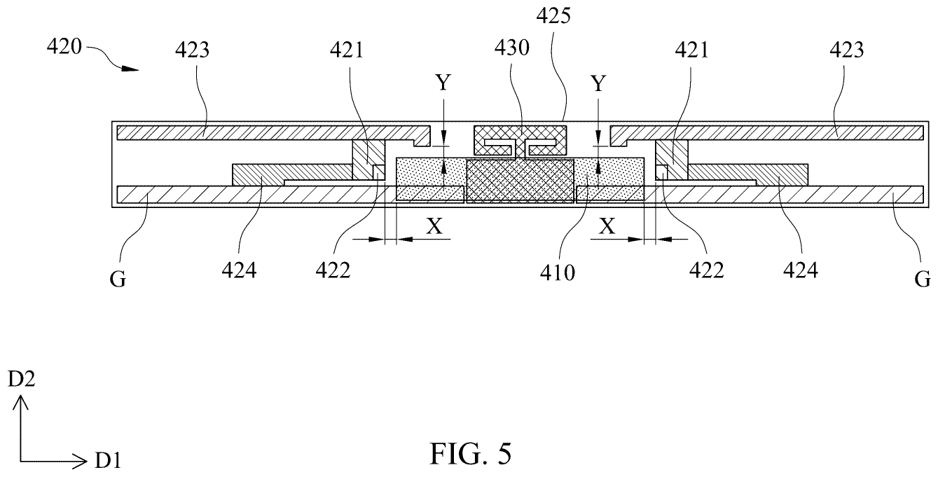

FIG. 5 is a schematic diagram of an antenna arrangement 400 of a fourth embodiment of the present disclosure. Referring to FIG. 5, the antenna arrangement 400 includes an image sensing module 410, an antenna module 420, and an isolation element 430. The isolation element 430 is electrically connected to the image sensing module 410. The differences between the fourth embodiment and the first embodiment lie in that the arrangement configuration of the image sensing module 410 and the antenna module 420, and that the antenna arrangement 400 further includes the isolation element 430.

An orthogonal projection of the antenna module 420 partially overlaps the image sensing module 410, and the image sensing module 410 is disposed between the two antennas of the antenna module 420. The antenna module 420 includes two first radiating parts 421, two feeding parts 422, two second radiating parts 423, two grounding parts 424, and a body 425. The two first radiating parts 421, the two second radiating parts 423, and the two grounding parts 424 are disposed on the body 425, and the two feeding parts 422 are respectively disposed on the two first radiating parts 421. The two first radiating parts 421 are respectively connected to the two second radiating parts 423, and the two grounding parts 424 are respectively connected to the two first radiating parts 421. It should be particularly noted that in other embodiments, the antenna ground and the isolation element can be part of the antenna module; the image sensing module may overlap with any part of the antenna module, as long as the image sensing module is kept away from the feeding part. For example, the image sensing module can overlap the second radiating part, and even if the positions of the feeding part and the grounding part are swapped, the image sensing module can still overlap the grounding part, but the present disclosure is not limited thereto.

In the fourth embodiment, the feeding part 422, the grounding part 424, and the body 425 are the same as the feeding part 122, the grounding part 124, and the body 125 of the first embodiment shown in FIG. 1, and will not be described herein; the antenna module 420 is a dual-antenna module, and the two planar inverted-F antennas (PIFA) are arranged oppositely, but the present disclosure is not limited thereto.

As shown in FIG. 5, each of the two feeding parts 422 is respectively separated from the image sensing module 410 along the first direction D1 by a first distance X, and each of the two second radiating parts 423 is respectively separated from the image sensing module 410 along the second direction D2 by a second distance Y. The second direction D2 is perpendicular to the first direction D1, and the vertical direction P is perpendicular to both the first direction D1 and the second direction D2. In the fourth embodiment, the first distance X is greater than or equal to 0.3 millimeters, and the second distance Y is greater than or equal to 0.3 millimeters, but the present disclosure is not limited thereto.

Thus, through the arrangement of the antenna module 420 and the image sensing module 410, the antenna module 420 and the image sensing module 410 can be disposed within limited installation space. Furthermore, by setting the first distance X and the second distance Y, the antenna module 420 can maintain optimal antenna characteristics.

The isolation element 430 is disposed between the two first radiating parts 421 to isolate the dual antennas. Specifically, the dual antennas will affect each other's antenna characteristics. Disposing the isolation element 430 between the opposite dual antennas can increase the isolation degree between the two antennas to avoid interference with each other's antenna characteristics.

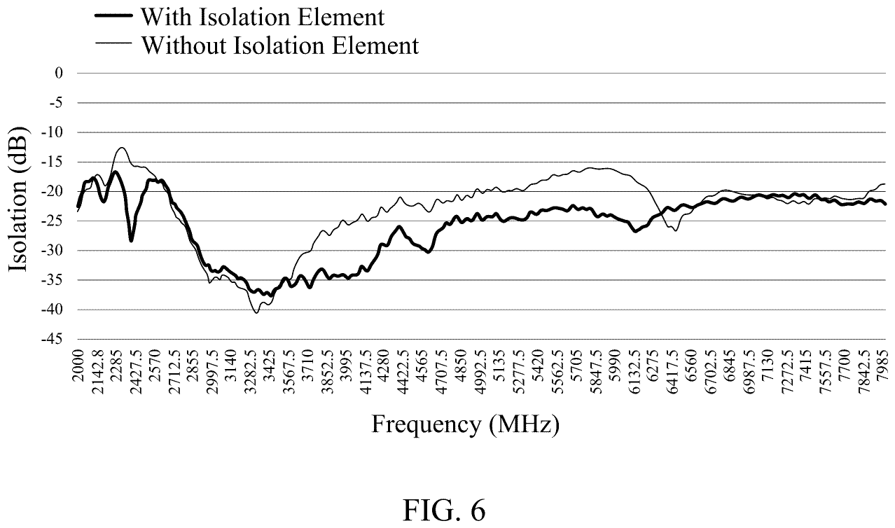

FIG. 6 is a comparative schematic diagram of the isolation degree of the antenna arrangement 400 of the fourth embodiment shown in FIG. 5. Referring to FIGS. 5 and 6, the image sensing module 410 disposed between the dual antennas has a similar function to a barrier wall isolating the dual antennas. By connecting the isolation element 430 with the image sensing module 410, the path of the barrier wall can be extended, further increasing the isolation degree. Specifically, from the antenna characteristic curve in FIG. 6, it can be seen that the antenna arrangement 400 with the isolation element 430 can significantly improve the isolation degree of the dual antennas compared to the one without the isolation element 430.

In view of the above, the present disclosure has the following advantages. First, through the partial overlapping arrangement of the antenna module and the image sensing module, the antenna module and the image sensing module are disposed in the notebook computer. Second, by setting the distances between the feeding part and the second radiating part and the image sensing module, the antenna module can maintain optimal antenna characteristics. Third, by disposing the isolation element between the dual antennas of the antenna module, the interference of the antenna characteristics of the dual antennas can be avoided.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna arrangement comprising:
an image sensing module; and
an antenna module, an orthogonal projection of the antenna module partially overlapping the image sensing module, the antenna module comprising:
a first radiating part; and
a feeding part disposed on the first radiating part;
wherein, there is a first distance between the feeding part and the image sensing module.

2. The antenna arrangement according to claim 1, wherein the antenna module further comprises:
a second radiating part connected to the first radiating part;
wherein, there is a second distance between the second radiating part and the image sensing module along a second direction, and the second direction is perpendicular to a first direction.

3. The antenna arrangement according to claim 2, wherein the second distance is greater than or equal to 0.3 millimeters.

4. The antenna arrangement according to claim 2, wherein the antenna module further comprises:
at least one grounding part connected to the second radiating part.

5. The antenna arrangement according to claim 2, wherein the image sensing module is stacked above the antenna module along a vertical direction so the orthogonal projection of the antenna module partially overlaps the image sensing module, and the vertical direction is perpendicular to the first direction and the second direction.

6. The antenna arrangement according to claim 1, wherein the antenna module further comprises:
a grounding part connected to the first radiating part.

7. The antenna arrangement according to claim 1, wherein the first distance is a linear shortest distance between the feeding part and the image sensing module, and the first distance is greater than or equal to 0.3 millimeters.

8. The antenna arrangement according to claim 1, wherein, there is a third distance between the first radiating part and the image sensing module along the first direction.

9. The antenna arrangement according to claim 8, wherein the third distance is greater than or equal to 0.3 millimeters.

10. The antenna arrangement according to claim 1, wherein the antenna module further comprises:
a grounding part, wherein an orthogonal projection of the grounding part partially overlaps the image sensing module.

11. The antenna arrangement according to claim 1, wherein the antenna module is a planar inverted-F antenna (PIFA), a coupled antenna, or a loop antenna.

12. An antenna arrangement, comprising:
an image sensing module;
an antenna module, an orthogonal projection of the antenna module partially overlapping the image sensing module, the antenna module comprising:
two first radiating parts; and
two feeding parts respectively disposed on the two first radiating parts; and
an isolation element electrically connected to the image sensing module and disposed between the two first radiating parts;
wherein, each of the two feeding parts is respectively separated from the image sensing module by a first distance.

13. The antenna arrangement according to claim 12, wherein the antenna module further comprises:
two second radiating parts respectively connected to the two first radiating parts;
wherein, each of the two second radiating parts is respectively separated from the image sensing module by a second distance along a second direction, and the second direction is perpendicular to a first direction.

14. The antenna arrangement according to claim 13, wherein the image sensing module is stacked above the antenna module along a vertical direction so the orthogonal projection of the antenna module partially overlaps the image sensing module, and the vertical direction is perpendicular to the first direction and the second direction.

15. The antenna arrangement according to claim 13, wherein the second distance is greater than or equal to 0.3 millimeters.

16. The antenna arrangement according to claim 12, wherein the antenna module further comprises:
two grounding parts respectively connected to the two first radiating parts.

17. The antenna arrangement according to claim 12, wherein the first distance is a linear shortest distance between each of the two feeding parts and the image sensing module, respectively, and the first distance is greater than or equal to 0.3 millimeters.
